(19) United States
(12) Patent Application Publication
(10) Pub. No.: US 2014/0245064 A1
(43) Pub. Date: Aug. 28, 2014

(54) INFORMATION PROCESSING APPARATUS, METHOD, AND PROGRAM

(71) Applicant: Sony Corporation, Tokyo (JP)

(72) Inventor: Satoru Iwasaki, Tokyo (JP)

(73) Assignee: Sony Corporation, Tokyo (JP)

(21) Appl. No.: 14/173,334

(22) Filed: Feb. 5, 2014

(30) Foreign Application Priority Data
Feb. 26, 2013 (JP) 2013-036302

(51) Int. Cl. G06F 11/14

(52) U.S. Cl. CPC G06F 11/1412
USPC 714/15

(57) ABSTRACT

An information processing apparatus includes: a similar-data detection section configured to detect similar data having a similarity with target data to be a target of processing in a main storage; and a difference saving section configured to extract a difference between criterial data selected from the similar data detected by the similar-data detection section and the target data, and to write the extracted difference in a save area.

### CROSS REFERENCE TO RELATED APPLICATIONS

This application claims the benefit of Japanese Priority Patent Application JP 2013-036302 filed Feb. 26, 2013, the entire contents of which are incorporated herein by reference.

### BACKGROUND

The present disclosure relates to an information processing apparatus, method, and program. In particular, the present disclosure relates to an information processing apparatus capable of reducing the amount of writing to a swap device, an information processing method, and an information processing program.

In a general system, when data in a main storage is swapped out, the contents of a page to be swapped out is simply written without change or the entire page is compressed and written into a swap device. However, even if a page is compressed, there is some reduction limit for a size of the page, and thus the amount of data written into the swap device becomes a certain size or more.

Accordingly, in Japanese Unexamined Patent Application Publication No. 2008-140236, only a page that was read from read-only data in a storage, such as a Read Only Memory (ROM), a flash memory, or the like, and used by having been rewritten, a difference with the read-only data in the ROM or the flash memory is extracted at the time of swap-out. And only the difference is written into a swap device so that the amount of writing is reduced.

In this regard, it is possible to classify data that is used by software at the time of operation into two kinds, that is to say, data that is generated by being read from a ROM or a flash memory, rewritten and used, and data that is dynamically generated by software at operation time (data that is not recorded into a ROM or a flash memory). In general, the latter data occupies an overwhelmingly larger portion of a main storage (tens of times to hundreds of times or more).

### SUMMARY

However, in the technique described in Japanese Unexamined Patent Application Publication No. 2008-140236, it has been possible only to reduce the amount of writing the former read-only data into a swap device out of the two kinds of data described above.

That is to say, rewriting the contents of the latter data might occur at any timing during system execution, and thus it has not been possible to easily extract a difference between pieces of similar data to swap out the difference in the same manner as in the case of the former read-only data.

The present disclosure has been made in view of these circumstances. It is desirable to make it possible to reduce the amount of writing into a swap device.

According to an embodiment of the present disclosure, there is provided an information processing apparatus including: a similar-data detection section configured to detect similar data having a similarity with target data to be a target of processing in a main storage; and a difference saving section configured to extract a difference between criterial data selected from the similar data detected by the similar-data detection section and the target data, and to write the extracted difference in a save area.

The above-described information processing apparatus may further include a rewrite request detection section configured to detect a rewrite request on the criterial data; when the rewrite request detection section detects a rewrite request on the criterial data, a data restoration section configured to restore data using the criterial data and a difference written in the difference saving section; and a data rewriting section configured to rewrite the criterial data on which the rewrite request detection section detected a rewrite request after the data restoration section restored the data.

The above-described information processing apparatus may further include a similarity-information generation section configured to group data on the basis of a similarity between pieces of data in the main storage, and to generate similarity information describing a similarity between the pieces of data, wherein the similar-data detection section may refer to the similarity information generated by the similarity-information generation section in order to detect similar data having the similarity with the target data in the main storage.

In the above-described information processing apparatus, the similarity-information generation section may group data on the basis of the similarity between pieces of data in the main storage in response to predetermined intervals, a load state, or an update request.

The above-described information processing apparatus may further include a rewrite detection section configured to detect an occurrence of rewriting data grouped by the similarity-information generation section, wherein if detected that rewriting data grouped by the rewrite detection section has occurred, the similarity-information generation section may group data on the basis of the similarity between pieces of data in the main storage, and may generate the similarity information.

The above-described information processing apparatus may further include a copy detection section configured to detect copy processing of data in the main storage, wherein the similarity-information generation section may group data by determining copy source data and copy destination data of the copy processing detected by the copy detection section to be pieces of data having a similarity, and may generate the similarity information.

In the above-described information processing apparatus, the similarity-information generation section may detect copy processing of data in the main storage, may group data by determining copy source data and copy destination data of the copy processing detected by the copy detection section to be pieces of data having a similarity, and may generate the similarity information.

The above-described information processing apparatus may further include a data restoration section configured to restore data using the criterial data and the difference written in the difference saving section.

In the above-described information processing apparatus, the save area may be disposed in a different storage medium from the main storage.

In the above-described information processing apparatus, the save area may be disposed in a different area in the main storage.

According to another embodiment of the present disclosure, there is provided a method of processing information, the method including: detecting similar data having a similarity with target data to be a target of processing in a main storage; and extracting a difference between criterial data selected from the similar data detected and the target data, and writing the extracted difference in a save area.

According to another embodiment of the present disclosure, there is provided a program for causing a computer to perform functions including: a similar-data detection section configured to detect similar data having a similarity with target data to be a target of processing in a main storage; and a difference saving section configured to extract a difference between criterial data selected from the similar data detected by the similar-data detection section and the target data, and to write the extracted difference in a save area.

According to an embodiment of the present disclosure, similar data having a similarity with target data to be a target of processing in a main storage is detected; and a difference is extracted between criterial data selected from the similar data detected and the target data, and the extracted difference is written in a save area.

By the present disclosure, it is possible to reduce the amount of writing into a swap device.

### BRIEF DESCRIPTION OF THE DRAWINGS

FIG. 1 is a block diagram illustrating a first example of a configuration of an information processing system to which the present technique is applied;

FIG. 2 is a diagram illustrating an example of similarity information;

FIG. 3 is a flowchart illustrating swap-out processing;

FIG. 4 is a flowchart illustrating swap-in processing;

FIG. 5 is a flowchart illustrating page grouping processing;

FIG. 6 is a flowchart illustrating update processing of similarity information;

FIG. 7 is a flowchart illustrating rewrite processing of a criterial page;

FIG. 8 is a block diagram illustrating a second example of a configuration of an information processing system to which the present technique is applied;

FIG. 9 is a block diagram illustrating a third example of a configuration of an information processing system to which the present technique is applied;

FIG. 10 is a flowchart illustrating grouping processing of a copy page;

FIG. 11 is a block diagram illustrating a fourth example of a configuration of an information processing system to which the present technique is applied; and

FIG. 12 is a block diagram illustrating an example of a configuration of a computer.

### DETAILED DESCRIPTION OF EMBODIMENTS

In the following, descriptions will be given of modes for carrying out the present disclosure (hereinafter referred to as embodiments). In this regard, the descriptions will be given in the following order.

1. First Embodiment

2. Second Embodiment

3. Third Embodiment

4. Fourth Embodiment

5. Fifth Embodiment

### 1. First Embodiment

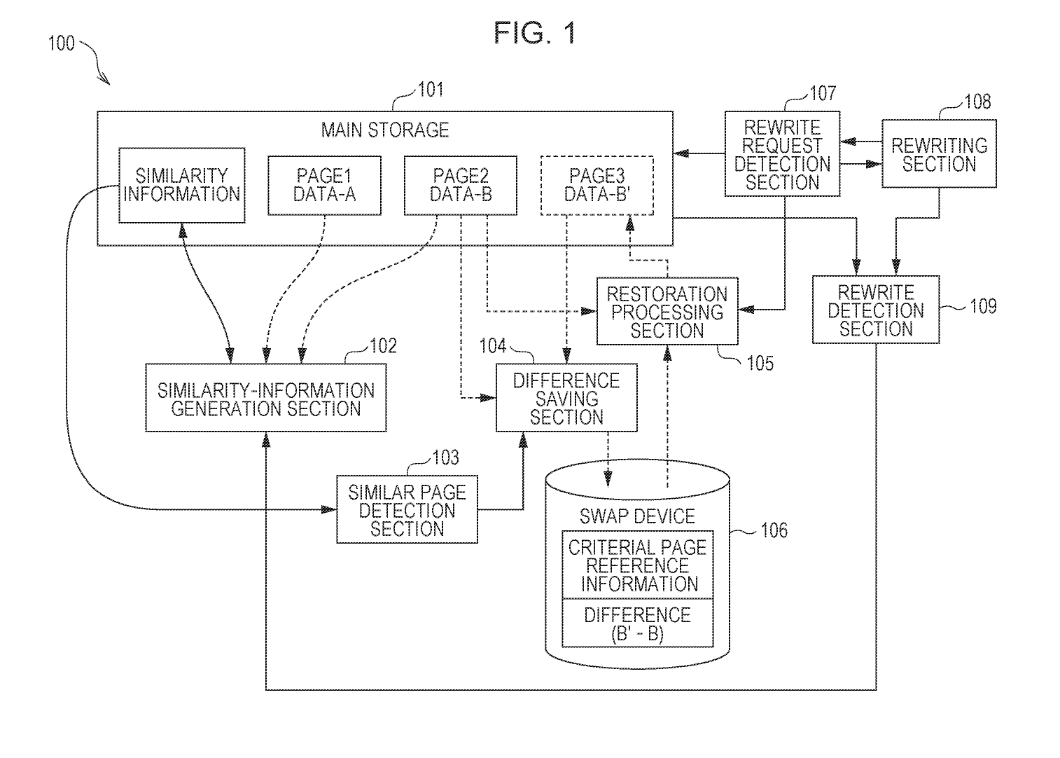

Example of configuration of information processing system FIG. 1 is a block diagram illustrating a first example of a configuration of an information processing system to which the present technique is applied.

In the example in FIG. 1, an information processing system 100 saves data written in a main storage 101 into a swap device 106, which is a save area, and performs processing to restore the saved data to the main storage 101. It is possible to apply the information processing system 100 to a personal computer, a multifunctional mobile phone, and the like, for example.

The information processing system 100 includes a main storage 101, a similarity-information generation section 102, a similar page detection section 103, a difference saving section 104, a restoration processing section 105, a swap device 106, a rewrite request detection section 107, a rewriting section 108, and a rewrite detection section 109.

The main storage 101 is constituted by a RAM (Random Access Memory) or the like, for example. The main storage 101 stores data that is managed in units called a page (hereinafter, simply referred to as a page) and similarity information generated by the similarity-information generation section 102. That is to say, in the similarity information, a similarity between pages is described as grouping information of the similar pages. In this regard, in the example in FIG. 1, the similarity information is stored in the main storage 101, and this is preferable. However, the similarity information may be stored in another storage medium.

The similarity-information generation section 102 groups (classifies into groups) pages on the basis of similarities of the pages in the main storage 101, and generates similarity information in which grouping information of similar pages is described. The similarity-information generation section 102 records and manages the generated similarity information in the main storage 101.

Also, the similarity-information generation section 102 performs page grouping on the basis of similarities of pages in the main storage 101 in response to a predetermined intervals, a system load state, a similarity-information update request from a user, a page rewrite occurrence, or the like, and updates the similarity information in the main storage 101. In this regard, a page rewrite occurrence is detected by the rewrite detection section 109, and the supplies the information to the similarity-information generation section 102.

The similar page detection section 103 detects a similar page to a target page of swap-out processing from the difference saving section 104 in the main storage 101, and supplies the detection result to the difference saving section 104. At that time, a method of detecting a similar page is not limited. For example, the similar page detection section 103 refers to the similarity information stored in the main storage 101, and detects a page similar to the target page from the main storage 101. Thereby, it is possible to search for a similar page at a high speed.

The difference saving section 104 performs swap-out processing, for example at the time when the capacity in the main storage 101 runs short of space, and in accordance with the free space in the main storage 101. That is to say, the difference saving section 104 extracts a difference between similar pages in the main storage 101, and writes out the extracted difference into the swap device 106 in order to save (swap out) the difference.

For example, one of the similar pages detected by the similar page detection section 103 is determined to be a criterial page. And the difference between the target page and the criterial page is extracted, and the extracted difference and the criterial page reference information are recorded in the swap device 106. The criterial page reference information is information that indicates which page is used for a criterion for difference extraction.

More specifically, in the example in FIG. 1, page1 includes data-A. Page2 includes data-B. Page3 includes data-B. If data-B and data-B′ are similar data, the difference saving section 104 swaps out page3 (data-B′). At that time, Page2 includes the data (data-B) having similar contents with the data (data-B′) of page3, and thus the difference saving section 104 records criterial page reference information indicating that page2 is used as a criterion, and the difference data (B′−B) between page2 and page3 in the swap device 106.

The restoration processing section 105 restores (swaps in) the page saved by the difference saving section 104 to the main storage 101. For example, when the rewrite request detection section 107 supplies information of a page for which a rewrite request has been detected, if there is data that has been swapped out using the page as a criterion, the restoration processing section 105 performs restoration processing.

That is to say, in the example in FIG. 1, the restoration processing section 105 refers to the criterial page reference information of the page (page3) to be restored, and copies the criterial page (page2) to a swap-in destination in the main storage 101. And the restoration processing section 105 reads the difference (B′−B) of the page to be restored from the swap device 106, and applies the difference to the criterial page (page2) of the swap-in destination so as to restore the page (page3) to be restored.

The swap device 106 is constituted by a flash memory or a hard disk drive, and so on, and stores the extracted difference and the criterial page reference information of the criterial page, which was a criterion at that time. In this regard, if a similar page is not detected, the entire page data is stored without change, or the page data is compressed and stored in the swap device 106.

The rewrite request detection section 107 detects a rewrite request on the page stored in the main storage 101 by the rewriting section 108. And if a page to be rewritten is a criterial page, the rewrite request detection section 107 supplies the information of the page detected by the rewrite request to the restoration processing section 105, causes to perform restoration processing, and permits the rewriting section 108 to perform rewriting after the completion of the restoration processing.

In this regard, if there is no data that has been swapped out using the page as the criterion, the rewrite request detection section 107 causes the rewriting section 108 to perform rewriting without restoration processing by the restoration processing section 105.

The rewriting section 108 rewrites the page in the main storage 101, and notifies the completion of the rewriting to the rewrite detection section 109, for example. In this regard, at the time of rewriting, if the page to be rewritten is a criterial page, it is possible for the rewriting section 108 to rewrite the page after the swapped-out page is restored by the rewrite request detection section 107 and the restoration processing section 105.

By the completion notification from the rewriting section 108, or regular confirmation of the contents of a page in the main storage 101, and so on, the rewrite detection section 109 detects rewriting of a page in the main storage 101, and causes the similarity-information generation section 102 to update the similarity information, for example.

As described above, in the information processing system 100, when free space runs short in the main storage 101, and so on, among the pages in the main storage 101, for example, pages having a low reference frequency are written into the swap device 106. Thereby, it is possible to make a free area in the main storage 101. At that time, if there is another page having similar contents as that of the page to be written (swapped out) in the main storage 101, the difference saving section 104 extracts the difference between them, and records the extracted difference and the criterial page reference information in the swap device 106. Thereby, it is possible to reduce the amount of writing into the swap device.

In this regard, specifically, it is possible to apply the information processing system 100 in FIG. 1 to a multifunctional mobile phone, and the like, for example. In this case, it is possible to implement the main storage 101 by a Dynamic Random Access Memory (DRAM), and to implement the swap device 106 by a flash storage, such as Embedded MultiMedia Card (eMMC)(trademark), or the like. Also, it is possible to implement the similarity-information generation section 102, the similar page detection section 103, the difference saving section 104, the restoration processing section 105, the rewrite request detection section 107, the rewriting section 108, and the rewrite detection section 109, and the like by software running on a Central Processing Unit (CPU), or a dedicated hardware logic. In this regard, it is also possible to implement the rewriting section 108 by an application that performs rewriting on a page.

Example of Similarity Information

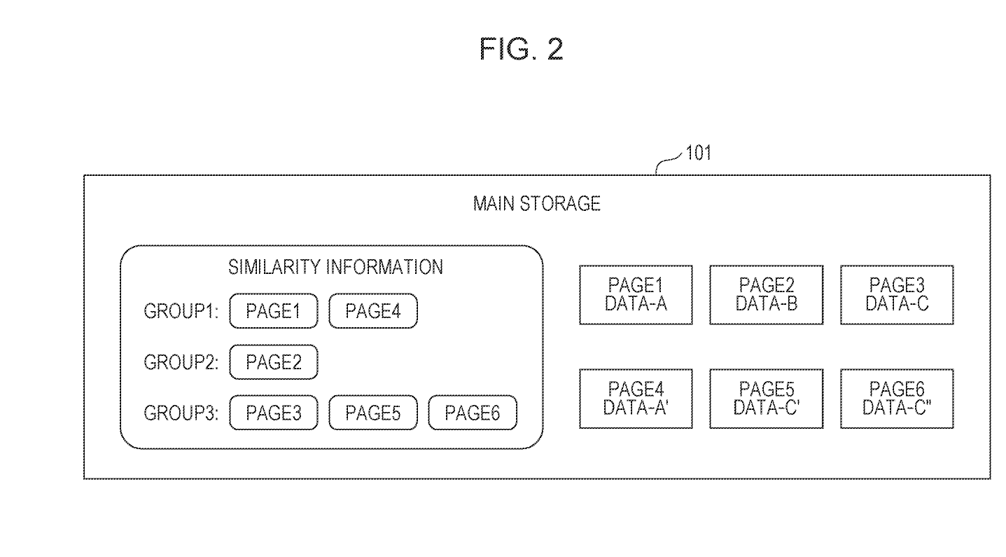

FIG. 2 is a diagram illustrating an example of similarity information.

The similarity information is a summary of necessary information in order to perform a high-speed search for information of whether there is another page having similar data in the main storage 101 for certain page data, and the location of the information, and so on.

For example, it is assumed that there are data-A and data-A′ having similar contents in the main storage 101 in page1 and page4, respectively. In this case, in the similarity information, page1 and page4 are classified in a same group, namely group1.

Also, for example, it is assumed that there is no data having similar contents as data-B in the main storage 101. Accordingly, in the similarity information, only page2 having data-B is classified in group2.

Further, for example, it is assumed that there are data C, data C′, and data C″ having similar contents in the main storage 101 in page3, page5, and page6, respectively. In this case, in the similarity information, page3, page5, and page6 are classified in a same group, namely group3.

By the classification in this manner, if asked which page has similar contents as that of page1, it is possible to detect page4 all at once. On the contrary, if asked which page has similar contents as that of page4, it is possible to detect page1 quickly.

Also, if asked which page has similar contents as that of page2, it is possible to reply that there is no page.

Further, if asked which page has similar contents as that of page3, it is possible to detect page5 and page6 promptly. If asked which page has similar contents as that of page5, it is possible to detect page3 and page6 immediately. In the same manner, if asked which page has similar contents as that of page6, it is possible to detect page3 and page5 promptly.

In this regard, the similarity information is constructed by the similarity-information generation section 102 searching for similar pieces of data in the main storage 101 when the information processing system 100 is in a low-load state, or at the timing instructed by an application that runs on the information processing system 100, and so on.

Also, as illustrated in FIG. 2, the similarity information may be disposed to have a structure such as a table located at one place in the main storage 101, or may be disposed distributed as a part of some data structure that exists in order to manage each page in the information processing system 100.

Example of Swap-Out Processing

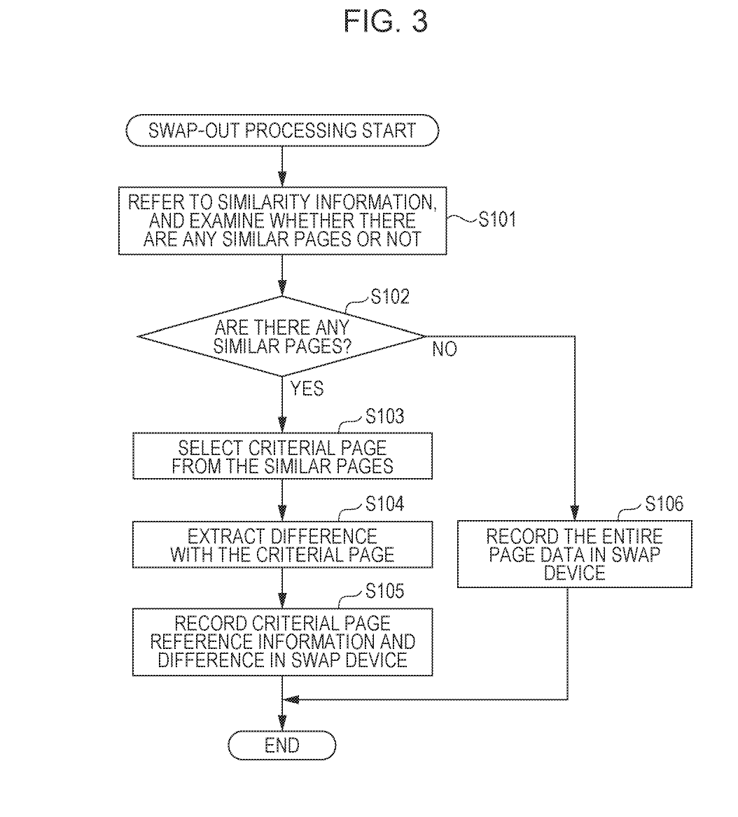

Next, a description will be given of a flow of swap-out processing of a page in the main storage 101 in order for the information processing system 100 to make a free area in the main storage 101 with reference to a flowchart in FIG. 3.

In step S101, the similar page detection section 103 refers to the similarity information in the main storage 101, and examines whether there are similar pages to a target page to be swapped out in the main storage 101. In step S102, the similar page detection section 103 determines whether there are similar pages or not.

In step S102, if determined that there are similar pages, the processing proceeds to step S103. In step S103, the similar page detection section 103 selects a criterial page to be a criterion from which the difference is extracted out of the similar pages, and supplies information on the swapped-out target page and information on the selected criterial page to the difference saving section 104.

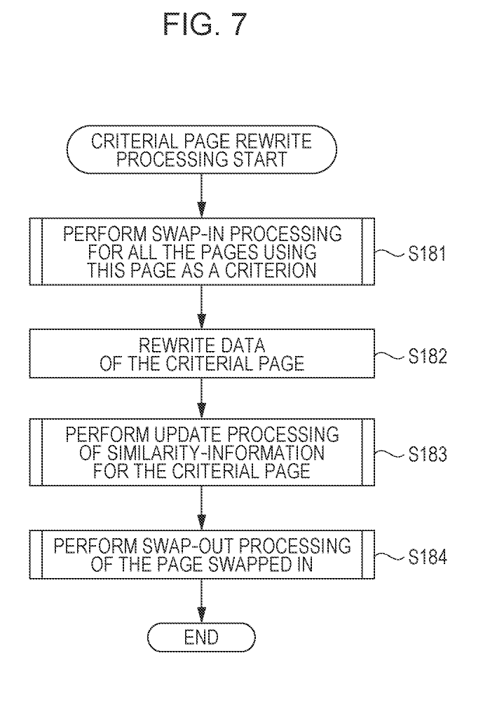

In this regard, an algorithm for selecting the page is not particularly limited. However, if a criterial page is rewritten after swap-out, it becomes necessary to perform rewrite processing of the criterial page, which will be described later with reference to FIG. 7. This might cause a load to be applied on the entire system. Accordingly, a rewrite frequency is counted in advance, for example, and in step S103, a page having as a low rewrite frequency as possible is selected as a criterial page.

In step S104, the difference saving section 104 extracts the difference between the swap-out target page and the criterial page. In step S105, the difference saving section 104 writes (records) the criterial page reference information, and the difference obtained in step S104 to the swap device 106.

On the other hand, in step S102, if determined that there is no similar page, the similar page detection section 103 supplies information only on the swap-out target page to the difference saving section 104, and the processing proceeds to step S106. In step S106, the difference saving section 104 writes (records) the entire page data to be the target in the swap device 106.

In step S106, in the same manner as a related-art method, the entire page data is written without change, or compressed and is then written into the swap device 106.

In this regard, as a variation of the processing in FIG. 3, both compression of the entire page data and difference extraction of similar data may be performed, and a comparison may be made between the amounts of data obtained from the individual results. And a result having a smaller amount of data may be written into the swap device 106.

Example of Swap-in Processing

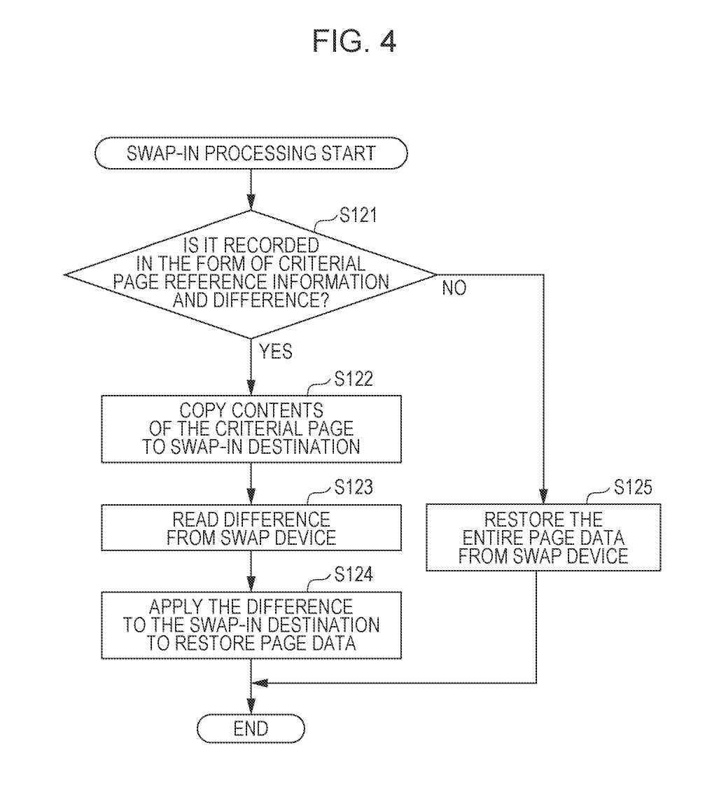

Next, a description will be given of processing for reading and restoring (swapping-in) a swapped-out page to the main storage 101 in order to allow the page to be referenced again with reference to a flowchart in FIG. 4.

In step S121, the restoration processing section 105 refers to the swap device 106 on the swap-in target page, and determines whether the swap-in target page is recorded in the form of the criterial page reference information and the difference, or the entire page data is recorded.

In step S121, if determined that the swap-in target page is recorded in the form of the criterial page reference information and the difference, the processing proceeds to step S122. In step S122, the restoration processing section 105 refers to the criterial page reference information, and copies the contents of the criterial page to the swap-in destination area in the main storage 101.

In step S123, the restoration processing section 105 reads the difference from the swap device 106. In step S124, the restoration processing section 105 applies the difference read in step S123 to the contents of the criterial page of the swap-in destination area, and restores the page data of the target page. That is to say, the restoration processing section 105 restores the data of the target page to have the same contents as the contents of the data before swap-out.

In step S121, if determined that the swap-in target page is not recorded in the form of the criterial page reference information and the difference, that is to say, that the entire page data is recorded, the processing proceeds to step S125. In step S125, the restoration processing section 105 restores the entire page data from the swap device 106. That is to say, the entire page data is read from the swap device 106, and is stored in the swap-in destination area to be restored. At this time, if the entire page data is compressed, the compression is uncompressed.

Example of Page Grouping Processing

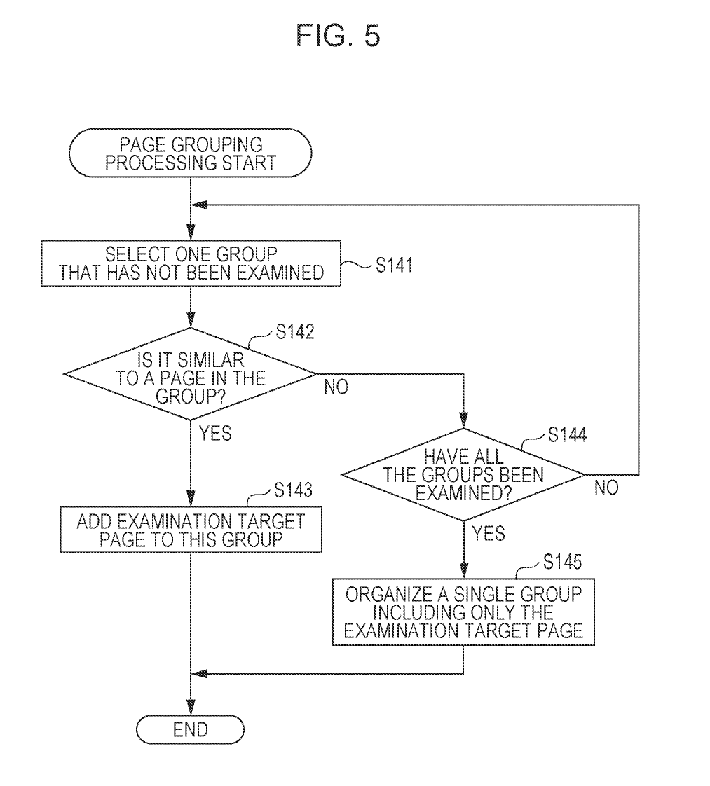

Next, a description will be given of grouping processing, which is processing for constructing the similarity information to be referenced by the above-described swap-out processing, and so on by searching for a similar page, with reference to a flowchart in FIG. 5.

In this regard, the example illustrated in FIG. 5 is processing for searching for a group to which a certain page ought to be stored. Accordingly, this processing is repeated for each page in the main storage 101 so that the construction of the similarity information for the entire information processing system 100 is completed. Also, in the initial state, it is assumed that every page constitutes a one-element group including only that page.

In step S141, the similarity-information generation section 102 selects one group in which the similarity to the search target page has not been examined yet. In step S142, the similarity-information generation section 102 determines whether the search target page is similar to the page in the group selected in step S141 or not. In this regard, a comparison is made with pages in the group here. However, for example, it is possible to select a representative page of a group in advance, and to make a comparison with only the representative page in order to increase the processing speed.

In step S142, if determined that the search target page is similar to a page in the group, the processing proceeds to step S143. In step S143, the similarity-information generation section 102 adds the search target page to the group selected in step S141.

On the other hand, in step S142, if determined that the search target page is not similar to a page in the group, the processing proceeds to step S144. In step S144, the similarity-information generation section 102 determines whether all the groups have been searched or not.

In step S144, if determined that all the groups have been searched, the processing proceeds to step S145. In step S145, the similarity-information generation section 102 forms a single group including only the search target page.

In step S144, if determined that all the groups have not been searched, the processing returns to step S141, and the subsequent processing is repeated.

In this regard, a determination of whether the contents among the pages are similar or not in the above-described step S142 is made by extracting the difference between the two pages. And if the difference is expressed by a sufficiently smaller value than a certain threshold value, the pages are determined to be similar, for example. Also, an existing technique, such as a method of comparing hash values calculated for the data of the individual pages, or the like may be used.

Example of Update Processing of Similarity Information

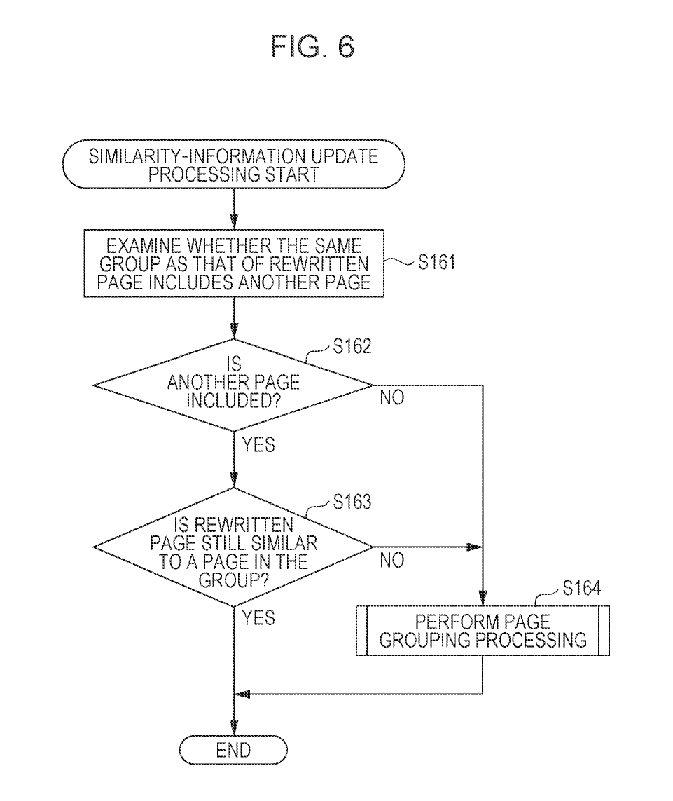

If the contents of a page (data) managed in the information processing system 100 are rewritten, there is a possibility that a similarity relationship among pages has been changed. Accordingly, it is necessary to suitably update the contents of the similarity information. A description will be given of a flow of this update processing with reference to a flowchart in FIG. 6.

In this regard, in the example in FIG. 6, for one page that has been rewritten, review processing of the grouping of that page is performed. This processing is performed for all the pages that have been rewritten in the information processing system 100. For example, a page that has been rewritten by the rewriting section 108 is detected by the rewrite detection section 109, and the information is supplied to the similarity-information generation section 102 to start this processing.

In step S161, the similarity-information generation section 102 refers to the similarity information in the main storage 101, and examines whether there is another page in the same group as that of the rewritten page. In step S162, the similarity-information generation section 102 determines whether there is another page in the same group as that of the rewritten page (that is to say, whether there is a similar page).

In step S162, if determined that there is another page in the same group as that of the rewritten page, the processing proceeds to step S163. In step S163, the similarity-information generation section 102 determines whether the rewritten page is still similar to a page in the group or not.

In step S163, if determined that the rewritten page is still similar to a page in the group, it is not necessary to update the similarity information, and thus the processing is directly terminated.

On the other hand, in step S162, if determined that there is not a page in the same group as that of the rewritten page, the processing proceeds to step S164. Also, in step S163, if determined that the rewritten page is not similar to any page in the group, the processing proceeds to step S164.

In step S164, the similarity-information generation section 102 performs grouping processing of the rewritten page. The grouping processing of the page is basically the same processing as the processing described above with reference to FIG. 5. And the description thereof will become repetitive, and thus is omitted.

In step S164, the rewritten page is grouped into a group of a similar page, and the update processing of the similarity information is terminated.

Example of Criterial Page Rewrite Processing

If a criterial page which has been a criterion for the swapped-out page as a difference is rewritten, it is not possible to properly restore the swapped-out data. Thus, a description will be given of criterial page rewrite processing, which is processing performed for a rewrite request of a criterial page, with reference to a flowchart in FIG. 7.

For example, the rewriting section 108 attempts to rewrite a certain page in the main storage 101. The rewrite request detection section 107 detects this rewrite request. If there is data swapped out using the page to be rewritten as a criterion, that is to say, if the page to be rewritten is a criterial page, the criterial page rewrite processing is started.

In this regard, whether a page to be rewritten is a criterial page or not may be determined with reference to each piece of criterial page reference information in the swap device 106. Also, alternatively, the similarity information may store which data is reference data for each group, and that information may be referenced.

In step S181, the rewrite request detection section 107 instructs the restoration processing section 105 to perform swap-in processing for all the pages using a criterial page to be rewritten as a criterion (swapped-out as a criterion). In this regard, the swap-in processing of this page is basically the same processing as the page swap-in processing described above with reference to FIG. 4, and thus the description thereof will be omitted.

When the restoration processing section 105 completes the swap-in processing for all the pages, the rewrite request detection section 107 permits a rewrite request of the rewriting section 108. In response to this, the rewriting section 108 rewrites the data of the criterial page.

When the rewriting section 108 rewrites a page in the main storage 101, the rewrite detection section 109 detects the rewriting, and supplies the rewriting to the similarity-information generation section 102, for example. In response to this, the similarity-information generation section 102 performs update processing of the similarity information for the rewritten criterial page in step S183. In this regard, the update processing of this similarity information is basically the same processing as the update processing of the similarity information described above with reference to FIG. 6. And the description thereof will become repetitive, and thus is omitted.

For example, when update of the similarity information is complete, in step S184, the similar page detection section 103 performs swap-out processing of the swapped-in page in step S181. In this regard, the swap-out processing is basically the same processing as the swap-out processing described above with reference to FIG. 3. And the description thereof will become repetitive, and thus is omitted.

As described above, before a criterial data is rewritten, the data swapped out using the criterial data as a criterion is swapped in, and thus even if there is swapped-out data, it is possible to properly restore the data.

In this regard, the processing in step S184 in FIG. 7 does not necessarily have to be performed. The processing may be omitted in accordance with a free space condition of the main storage 101 in the information processing system 100 at that time. Also, the processing may wait until the time when the capacity of the main storage 101 in the information processing system 100 runs short. At that time, the swap-out processing is automatically performed again.

### 2. Second Embodiment

Example of configuration of information processing system

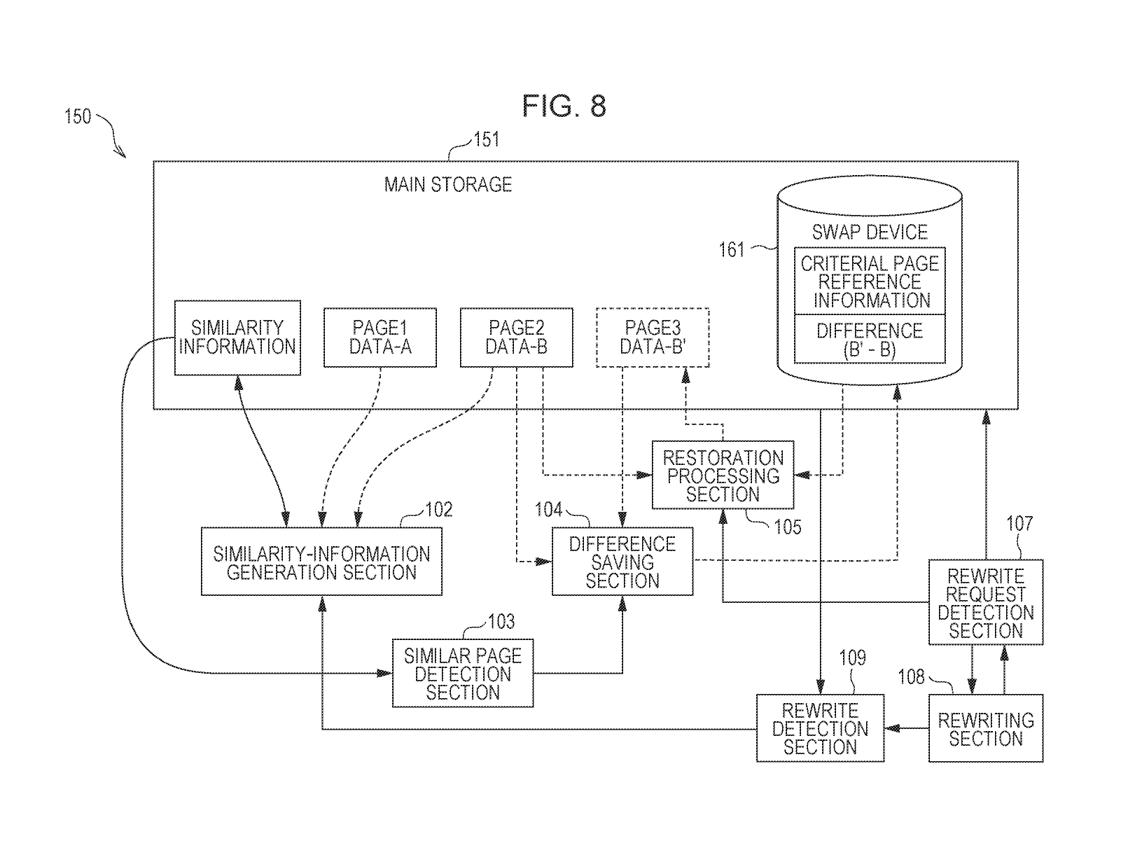

FIG. 8 is a block diagram illustrating a second example of a configuration of an information processing system to which the present technique is applied.

In the example in FIG. 8, an information processing system 150 saves data written in a main storage 151 into a swap device 161, which is a save area in the main storage 151, and also performs processing to restore the saved data to the main storage 151.

The information processing system 150 includes the similarity-information generation section 102, the similar page detection section 103, the difference saving section 104, the restoration processing section 105, the rewrite request detection section 107, the rewriting section 108, and the rewrite detection section 109 in common with the information processing system 100 in FIG. 1.

The information processing system 150 is different from the information processing system 100 in FIG. 1 in the points that the main storage 101 is replaced by the main storage 151 including an area as the swap device 161, and the swap device 106 on the storage medium that is different from the main storage 101 is replaced by the swap device 161 in the main storage 101.

That is to say, the information processing system 150 is different from the information processing system 100 only in the point that the swap device 161 is constituted in the main storage 151. Accordingly, the processing of the information processing system 150 is basically the same processing as the information processing system 100 described above. And the description thereof will become repetitive, and thus is omitted.

In this regard, it is assumed that the size of the swap device 161 that occupies the main storage 151 is variable in accordance with the amount of data written in the swap device 161. In this case, the swap-out processing is processing for contracting data having a low reference frequency in the main storage 151 into a form of the difference and relocating the data. As a result, the amount of use of the main storage 151 in the entire information processing system 150 is reduced.

### 3. Third Embodiment

### Example of Configuration of Information Processing System

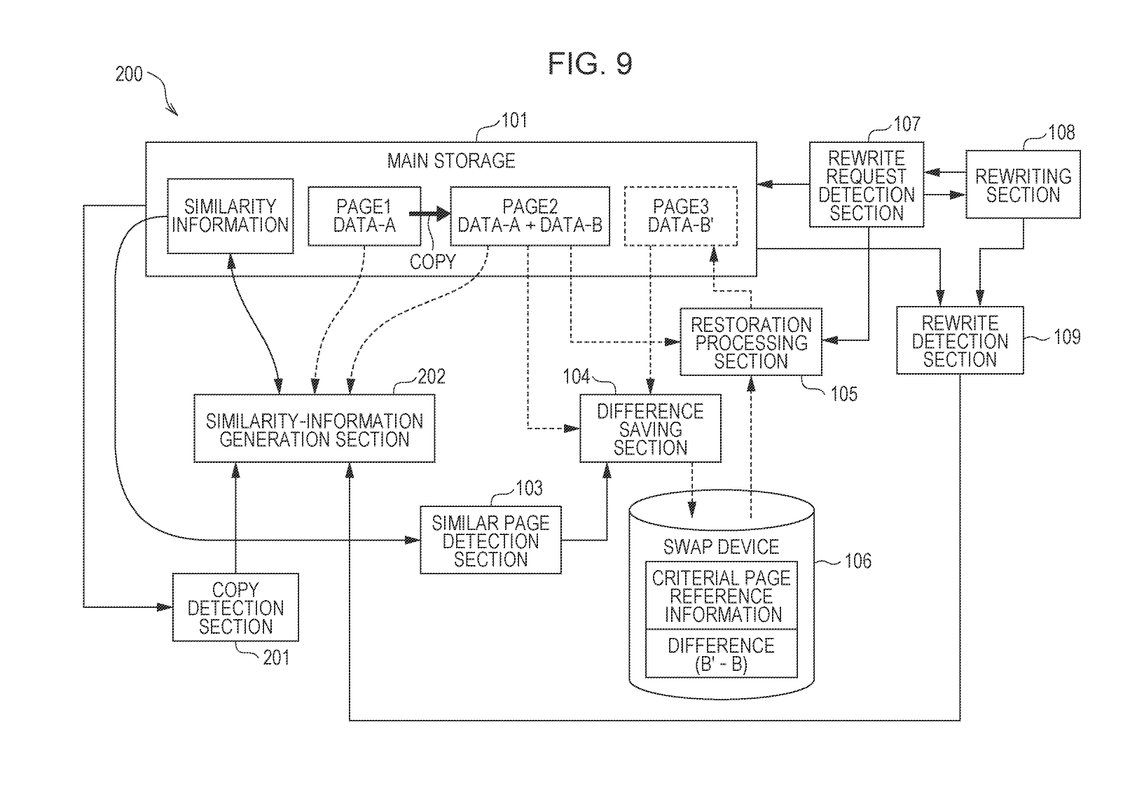

FIG. 9 is a block diagram illustrating a third example of a configuration of an information processing system to which the present technique is applied.

In the example in FIG. 9, in the same manner as the information processing system 100 in FIG. 1, an information processing system 200 saves data written in the main storage 101 in a swap device 106, which is a save area, and also performs processing to restore the saved data to the main storage 101.

The information processing system 200 includes the main storage 101, the similar page detection section 103, the difference saving section 104, the restoration processing section 105, the swap device 106, the rewrite request detection section 107, the rewriting section 108, and the rewrite detection section 109 in common with the information processing system 100 in FIG. 1.

The information processing system 200 is different from the information processing system 100 in FIG. 1 in the points that a copy detection section 201 is added, and the similarity-information generation section 102 is replaced by a similarity-information generation section 202.

That is to say, the copy detection section 201 detects data copy processing performed in the main storage 101, and supplies the page information (information on a copy source page and a copy destination page) of the detected copy processing to the similarity-information generation section 202.

For example, in the example in FIG. 9, data-A in page1 is copied to page2. The copy detection section 201 detects the copy processing, and supplies information on a copy source page (page1) and a copy destination page (page2) as page information of the copy processing to the similarity-information generation section 202.

In the same manner as the similarity-information generation section 102 in FIG. 1, the similarity-information generation section 202 groups pages on the basis of similarities of pages in the main storage 101, and generates similarity information in which grouping information of similar pages is described. The similarity-information generation section 202 records and manages the generated similarity information in the main storage 101.

Also, in the same manner as the similarity-information generation section 102 in FIG. 1, the similarity-information generation section 202 performs page grouping on the basis of similarities of pages in the main storage 101 in response to a predetermined intervals, a system load state, a similarity-information update request from a user, a page rewrite occurrence, or the like, and updates the similarity information managed in the main storage 101.

Further, unlike the similarity-information generation section 102 in FIG. 1, the similarity-information generation section 202 refers to copy processing page information supplied from the copy detection section 201, performs grouping of pages on the basis of the similarities of the pages, and updates the similarity information managed by the main storage 101.

In this regard, it is thought that a mechanism like this copy detection section 201 is disposed, for example, in the copy-on-write processing executed by an Operating System (OS), and a memory copy function provided by an application library, or the like.

Example of Copy-Page Grouping Processing

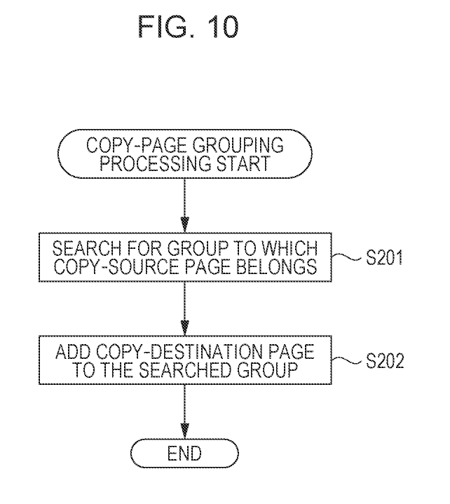

Next, a description will be given of grouping processing on copy pages in the information processing system 200 with reference to a flowchart in FIG. 10. In this regard, the other processing in the information processing system 200 is basically the same processing as the processing of the information processing system 100 in FIG. 1. Accordingly, the description thereof will become repetitive, and thus is omitted.

For example, the copy detection section 201 detects data copy processing executed in the main storage 101, and supplies the page information (information on a copy source page and a copy destination page) of the detected copy processing to the similarity-information generation section 202.

In step S201, the similarity-information generation section 202 refers to the similarity information, and searches for a group to which the copy source page belongs. In step S202, the similarity-information generation section 202 adds the copy destination page to the group to which the copy source page belongs, and the processing is terminated.

Although this processing is allowed to detect only the similarities brought about by the data copy processing in comparison with the page grouping processing by searching for the similar pages described above with reference to FIG. 5, this processing has a merit that the processing load is very low.

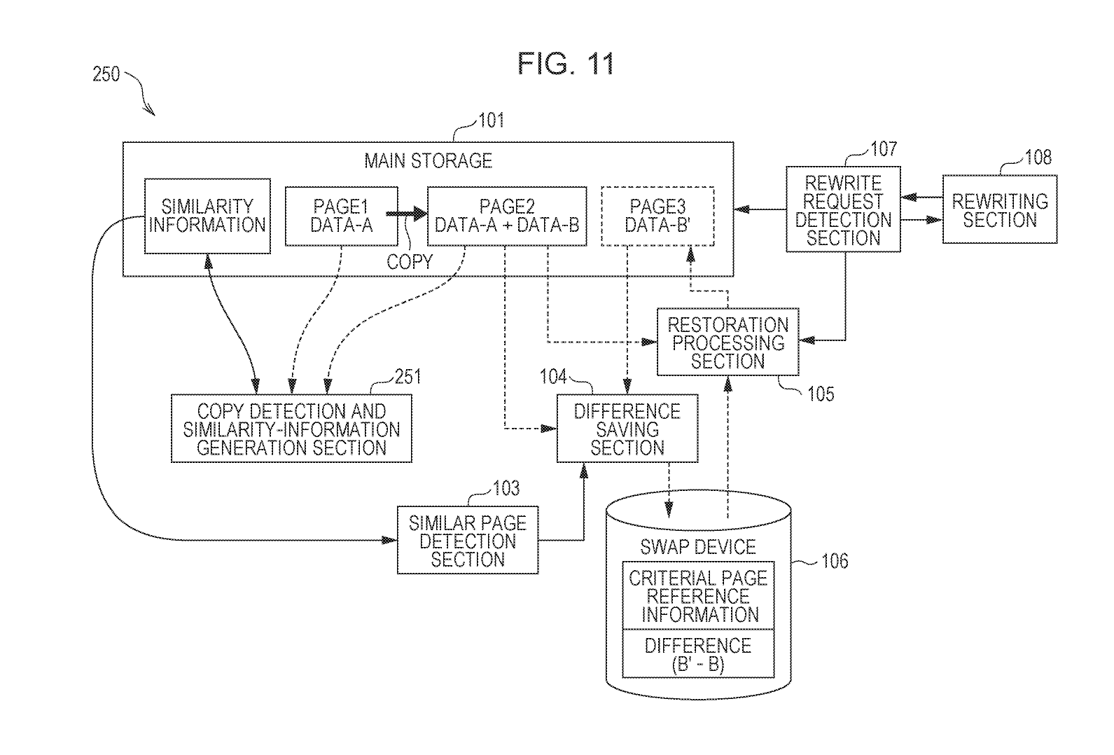

In this regard, in the example in FIG. 9, a description has been given of an example of the information processing system 200, which is a system using the copy detection section 201 in combination in addition to the page grouping processing by searching similar pages. On the other hand, in a system for which a low load is requested, and so on, it is possible to provide a system using the copy detection mechanism as illustrated in FIG. 11 without using the page grouping processing by searching for similar pages.

### 4. Fourth Embodiment

### Example of Configuration of Information Processing System

FIG. 11 is a block diagram illustrating a fourth example of a configuration of an information processing system to which the present technique is applied.

In the example in FIG. 11, in the same manner as the information processing system 100 in FIG. 1, an information processing system 250 saves data written in the main storage 101 in a swap device 106, which is a save area, and also performs processing to restore the saved data to the main storage 101.

The information processing system 250 includes the main storage 101, the similar page detection section 103, the difference saving section 104, the restoration processing section 105, the swap device 106, the rewrite request detection section 107, and the rewriting section 108 in common with the information processing system 100 in FIG. 1.

The information processing system 250 is different from the information processing system 100 in FIG. 1 in the points that the rewrite detection section 109 is removed, and the similarity-information generation section 102 is replaced by a copy detection and similarity-information generation section 251.

The copy detection and similarity-information generation section 251 detects data copy processing executed in the main storage 101, refers to the page information (information on a copy source page and a copy destination page) of the detected copy processing, and performs page grouping of the pages on the basis of the similarities to generate the similarity information.

That is to say, the copy detection similarity-information generation section 251 is a combination of the copy detection section 201 in FIG. 9, and the similarity-information generation section 202 that performs only the grouping processing with reference to the page information of the copy processing, and thus may be constituted by the combination of those.

In this regard, the processing of the information processing system 250 in FIG. 11 performs basically the same processing as the swap-out processing in FIG. 3, the swap-in processing in FIG. 4, the processing in steps S181 and S182 in FIG. 7, and the copy page grouping processing in FIG. 10, for example. Accordingly, And the description thereof will become repetitive, and thus is omitted.

As described above, by the present technique, it is possible to reduce the amount of writing to any page of a swap device formed by a Read Only Memory (ROM) or a flash memory that does not include original data. Thereby, it is possible to lower costs, and the like.

Also, in the case of the information processing system in FIG. 8, it is possible to reduce the amount of installed main storage instead of the swap device, and thus it is possible to lower costs, and the like. Alternatively, in the case of not reducing the amount of main storage, it is possible to increase a free area of the main storage at the time of running the same applications as before. Accordingly, it becomes possible to use the same applications more comfortably, or to run the larger number of applications at the same time at ease.

The above-described series of processing can be executed by hardware or can be executed by software. When the series of processing is executed by software, programs of the software may be installed in a computer. Here, the computer includes a computer that is built in a dedicated hardware, and for example, a general-purpose personal computer, etc., capable of executing various functions by installing various programs.

### 5. Fifth Embodiment

### Computer

### Example of Configuration of Computer

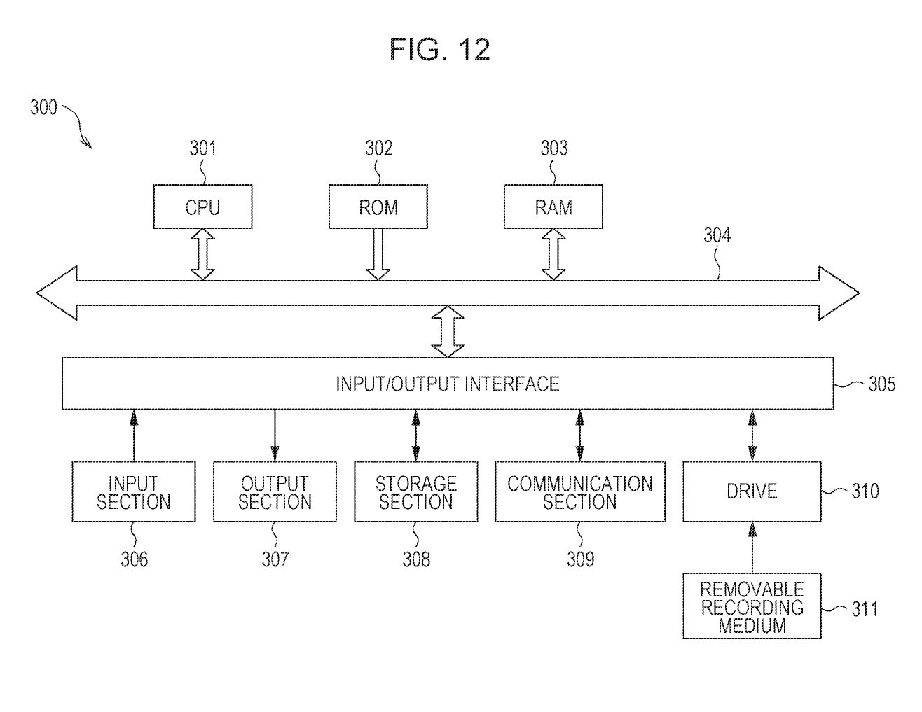

FIG. 12 illustrates an example of a hardware configuration of a computer that executes the above-described series of processing by a program.

In a computer 300, a CPU 301, a ROM 302, and a RAM 303 are mutually connected through a bus 304.

Further, an input/output interface 305 is connected to the bus 304. An input section 306, an output section 307, a storage section 308, a communication section 309, and a drive 310 are connected to the input/output interface 305.

The input section 306 includes a keyboard, a mouse, a microphone, and the like. The output section 307 includes a display, a speaker, and the like. The storage section 308 includes a hard disk, a nonvolatile memory, and the like. The communication section 309 includes a network interface, etc. The drive 310 drives a removable medium 311, such as a magnetic disk, an optical disc, a magneto-optical disc, or a semiconductor memory, and the like.

In the computer 300 having the configuration as described above, the CPU 301 loads the program stored, for example in storage section 308 to the RAM 303 through the input/output interface 305 and the bus 304 to execute the program, thereby the above-described series of processing is performed.

The program to be executed by the computer 300 (the CPU 301) can be provided by being recorded on a removable medium 311 as a package medium, etc., for example. Also, it is possible to provide the program through a wired or a wireless transmission medium, such as a local area network, the Internet, a digital satellite broadcasting, and the like.

In the computer 300, the programs can be installed in the storage section 308 through the input/output interface 305 by attaching the removable medium 311 to the drive 310. Also, the program can be received by the communication section 309 through a wired or wireless transmission medium and can be installed in the storage section 308. In addition, the program may be installed in the ROM 302 or the storage section 308 in advance.

In this regard, the programs executed by the computer 300 may be programs that are processed in time series in accordance with the described sequence in this specification. Alternatively, the programs may be programs to be executed in parallel or at necessary timing, such as at the time of being called, or the like.

In this regard, in the present specification, the steps describing the above-described series of processing includes, of course, processing to be performed in sequence, but also includes processing not necessarily processed in time series in accordance with the described sequence, that is to say, processing to be performed in parallel or individually.

Also, embodiments in the present disclosure are not limited to the above-described embodiments, and various variations are possible without departing from the spirit and scope of the present disclosure.

For example, it is possible to configure the present technique by cloud computing, in which one function is shared and coordinated by a plurality of apparatuses through a network.

Also, it is possible to share each step described in the above flowchart among a plurality of apparatuses in addition to performing each step by one apparatus.

Further, in the case where one step includes a plurality of pieces of processing, the plurality of pieces of processing included in the one step may be shared and executed by a plurality of apparatuses in addition to execution by one apparatus.

Also, in the above, a component described as one apparatus (or processing section) may be divided and configured as a plurality of apparatuses (or processing sections). On the contrary, components described as a plurality of apparatuses (or processing sections) may be put together into one apparatus (or processing section). Also, a component other than described above may be added to the component of individual apparatus (or individual processing section). Further, if the configuration and the operation of the overall system are substantially the same, a part of a component of a certain apparatus (or processing section) may be included in a component of another apparatus (or another processing section). That is to say, the present technique is not limited to the above-described embodiments, and it is possible to make various alterations without departing from the spirit and scope of the present technique.

In the above, detailed descriptions have been given of preferable embodiments of the present disclosure with reference to the accompanying drawings. However, the present disclosure is not limited to those examples. It is obvious to a person who has a common knowledge in the technical field to which the present disclosure pertains that various changes or modifications may be made within the spirit and scope of the appended claims. Such changes and modifications are of course construed within the spirit and scope of the present disclosure.

In this regard, it is possible to configure the present technique as follows.

(1) An information processing apparatus including: a similar-data detection section configured to detect similar data having a similarity with target data to be a target of processing in a main storage; and a difference saving section configured to extract a difference between criterial data selected from the similar data detected by the similar-data detection section and the target data, and to write the extracted difference in a save area.

(2) The information processing apparatus according to (1), further including: a rewrite request detection section configured to detect a rewrite request on the criterial data; when the rewrite request detection section detects a rewrite request on the criterial data, a data restoration section configured to restore data using the criterial data and a difference written in the difference saving section; and a data rewriting section configured to rewrite the criterial data on which the rewrite request detection section detected a rewrite request after the data restoration section restored the data.

(3) The information processing apparatus according to (1) or (2), further including a similarity-information generation section configured to group data on the basis of a similarity between pieces of data in the main storage, and to generate similarity information describing a similarity between the pieces of data, wherein the similar-data detection section refers to the similarity information generated by the similarity-information generation section in order to detect similar data having the similarity with the target data in the main storage.

(4) The information processing apparatus according to (3), wherein the similarity-information generation section groups data on the basis of the similarity between pieces of data in the main storage in response to predetermined intervals, a load state, or an update request.

(5) The information processing apparatus according to (3), further including a rewrite detection section configured to detect an occurrence of rewriting data grouped by the similarity-information generation section, wherein if detected that rewriting data grouped by the rewrite detection section has occurred, the similarity-information generation section groups data on the basis of the similarity between pieces of data in the main storage, and generates the similarity information.

(6) The information processing apparatus according to (3), further including: a copy detection section configured to detect copy processing of data in the main storage, wherein the similarity-information generation section groups data by determining copy source data and copy destination data of the copy processing detected by the copy detection section to be pieces of data having a similarity, and generates the similarity information.

(7) The information processing apparatus according to (3), wherein the similarity-information generation section detects copy processing of data in the main storage, groups data by determining copy source data and copy destination data of the copy processing detected by the copy detection section to be pieces of data having a similarity, and generates the similarity information.

(8) The information processing apparatus according to (3), further including: a data restoration section configured to restore data using the criterial data and the difference written in the difference saving section.

(9) The information processing apparatus according to any one of (1) to (8), wherein the save area is disposed in a different storage medium from the main storage.

(10) The information processing apparatus according to any one of (1) to (8), wherein the save area is disposed in a different area in the main storage.

(11) A method of processing information, the method including: detecting similar data having a similarity with target data to be a target of processing in a main storage; and extracting a difference between criterial data selected from the similar data detected and the target data, and writing the extracted difference in a save area.

(12) A program for causing a computer to perform functions including: a similar-data detection section configured to detect similar data having a similarity with target data to be a target of processing in a main storage; and a difference saving section configured to extract a difference between criterial data selected from the similar data detected by the similar-data detection section and the target data, and to write the extracted difference in a save area.

What is claimed is:

1. An information processing apparatus comprising:
a similar-data detection section configured to detect similar data having a similarity with target data to be a target of processing in a main storage; and
a difference saving section configured to extract a difference between criterial data selected from the similar data detected by the similar-data detection section and the target data, and to write the extracted difference in a save area.

2. The information processing apparatus according to claim 1, further comprising:
a rewrite request detection section configured to detect a rewrite request on the criterial data;
when the rewrite request detection section detects a rewrite request on the criterial data, a data restoration section configured to restore data using the criterial data and a difference written in the difference saving section; and
a data rewriting section configured to rewrite the criterial data on which the rewrite request detection section detected a rewrite request after the data restoration section restored the data.

3. The information processing apparatus according to claim 1, further comprising
a similarity-information generation section configured to group data on the basis of a similarity between pieces of data in the main storage, and to generate similarity information describing a similarity between the pieces of data,
wherein the similar-data detection section refers to the similarity information generated by the similarity-information generation section in order to detect similar data having the similarity with the target data in the main storage.

4. The information processing apparatus according to claim 3,
wherein the similarity-information generation section groups data on the basis of the similarity between pieces of data in the main storage in response to predetermined intervals, a load state, or an update request.

5. The information processing apparatus according to claim 3, further comprising
a rewrite detection section configured to detect an occurrence of rewriting data grouped by the similarity-information generation section,
wherein if detected that rewriting data grouped by the rewrite detection section has occurred, the similarity-information generation section groups data on the basis of the similarity between pieces of data in the main storage, and generates the similarity information.

6. The information processing apparatus according to claim 3, further comprising:
a copy detection section configured to detect copy processing of data in the main storage,
wherein the similarity-information generation section groups data by determining copy source data and copy destination data of the copy processing detected by the copy detection section to be pieces of data having a similarity, and generates the similarity information.

7. The information processing apparatus according to claim 3,
wherein the similarity-information generation section detects copy processing of data in the main storage, groups data by determining copy source data and copy destination data of the copy processing detected by the copy detection section to be pieces of data having a similarity, and generates the similarity information.

8. The information processing apparatus according to claim 3, further comprising
a data restoration section configured to restore data using the criterial data and the difference written in the difference saving section.

9. The information processing apparatus according to claim 1,
wherein the save area is disposed in a different storage medium from the main storage.

10. The information processing apparatus according to claim 1,
wherein the save area is disposed in a different area in the main storage.

11. A method of processing information, the method comprising:
detecting similar data having a similarity with target data to be a target of processing in a main storage; and
extracting a difference between criterial data selected from the similar data detected and the target data, and writing the extracted difference in a save area.

12. A program for causing a computer to perform functions comprising:
a similar-data detection section configured to detect similar data having a similarity with target data to be a target of processing in a main storage; and
a difference saving section configured to extract a difference between criterial data selected from the similar data detected by the similar-data detection section and the target data, and to write the extracted difference in a save area.
